(19) United States
(12) Patent Application Publication
(10) Pub. No.: US 2009/0077590 A1
(43) Pub. Date: Mar. 19, 2009

(54) SYSTEM AND METHOD FOR PRESENTING AN ELECTRONIC PROGRAM GUIDE

(75) Inventor: Martinus S. Nielen, Best (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,170

(22) PCT Filed: Nov. 15, 2005
(86) PCT No.: PCT/IB2005/053761

§ 371 Date: May 11, 2007

Related U.S. Application Data
(60) Provisional application No. 60/628,068, filed on Nov. 15, 2004.

(51) Int. Cl. H04N 5/445

(52) U.S. Cl. 725/47

(57) ABSTRACT

An improved electronic program guide (EPG) (200) is provided which assists a viewer to quickly and easily identify programs of interest by displaying limited schedule information. The improved EPG (200) includes a series of time tab increments (203) demarcating the start and stop times in minutes of the displayed scheduling information relative to a viewer selected display time (205). In this manner, the viewer is aware of exactly how much time has elapsed and exactly how much time remains to the end of each currently broadcasted program. According to one aspect, a viewer has the option of toggling between the EPG display (200) and an alternate EPG display (700) which further filters the limited schedule information to include only favorite channels of the viewer.

The present invention relates generally to the presentation of television electronic program guide (EPG) information to a television viewer. More particularly, the present invention relates to a method for assisting a viewer to quickly and easily identify programs of interest by displaying limited schedule information.

The ever increasing number of broadcast channels has created a need to inform potential viewers about the programs that are scheduled to air on those channels. Broadcasters such as cable television companies typically provide a user interface called an Electronic Program Guide (“EPG”). As is known in the art, the EPG provides viewers with on-screen listings of upcoming television programs on cable television channels. The on-screen listings typically include the channels, start and stop times, program descriptions and synopses. Some listings may also include program lengths, program ratings and program genres. EPGs often display their data in a two-dimensional grid with rows of the grid representing available channels and columns representing time periods, such as a half hour or hour. In each cell of the grid, the EPG displays the title of the event that will air at the corresponding time and channel.

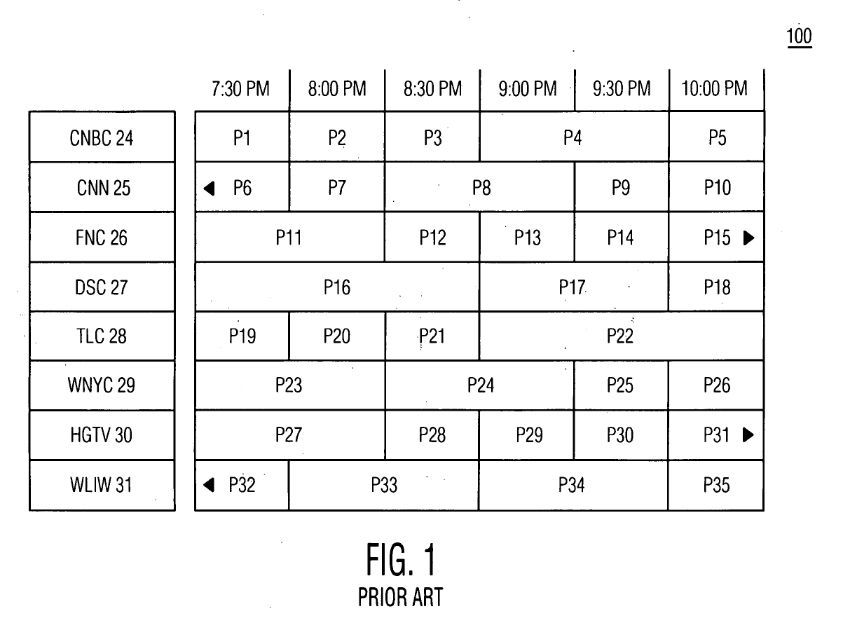

FIG. 1 shows an example of a typical EPG 100 wherein the grid's displayed period is from 7:00 p.m. to 10:00 p.m. for channels 24 through 31. Several program cells in the grid have indications (arrows) that the programs they correspond to start at times before the beginning of the grid's displayed period (e.g., program P6 which starts at 6:30 p.m. and program P32 which start at 7:00 p.m.). Several other program cells in the grid have indications that the programs they correspond to end at times after the end of the grid's displayed period (e.g., program P15 which ends at 10:30 p.m. and program P31 which ends at 11:00 p.m.).

While the EPG grid 100 of FIG. 1 is widely used and has utility, it suffers from not enabling a user to quickly and easily find content of interest. In other words, it is generally complex and therefore potentially daunting to many viewers who need to extract information at a glance. Another drawback of the exemplary EPG grid 100 of FIG. 1, discussed above, is that a viewer is not aware to what extent the programs start times precede the displayed start time, (e.g., programs P6 and P32) and to what extent the programs end times exceed the displayed end time, (e.g., programs P15 and P31).

What is needed, therefore, is an EPG that displays scheduling information in a simple and straightforward manner which assists a viewer to quickly and easily identify programs of interest.

The present invention addresses these and other problems in the prior art by providing an improved electronic program guide (EPG) which assists a viewer to quickly and easily identify programs of interest by displaying limited schedule information. More particularly, the improved EPG displays only displays information which is scheduled to be aired by a broadcast system during a viewer selected display time thereby facilitating quick and easy identification of programs of interest. Those programs typically displayed in a conventional grid format which either have already been aired or have yet to be aired are excluded (filtered) from the EPG display thereby making the EPG display less complex and daunting to the viewer.

According to one aspect of the invention, the improved EPG includes a series of time tab increments demarcating the start and stop times in minutes of the displayed scheduling information relative to a user selected display time. In this manner, the viewer is aware of exactly how much time has elapsed and exactly how much time remains to the end of each currently broadcasted program.

According to another aspect, a viewer has the option of constructing, in real time, a “favorites list” of programs. The programs selected for inclusion in the “favorites list” are selectable from the improved EPG display and are highlighted in the improved EPG display upon selection. The viewer has the option of toggling between the improved EPG display and the “favorites list” at any time.

The foregoing features of the present invention will become more readily apparent and may be understood by referring to the following detailed description of an illustrative embodiment of the present invention, taken in conjunction with the accompanying drawings, where:

FIG. 1 is an illustration of a typical EPG in accordance with the prior art;

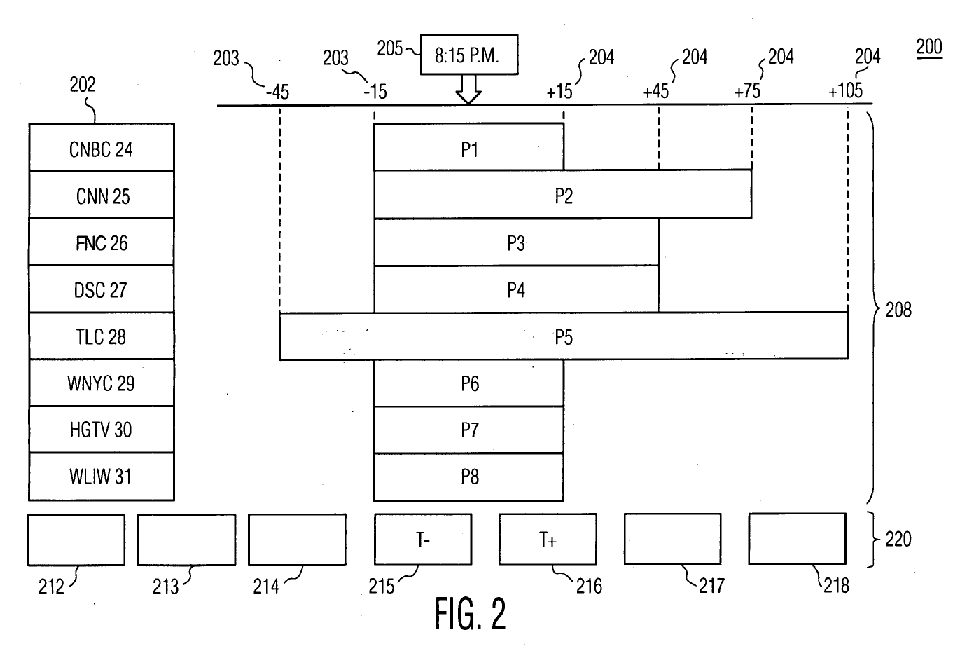

FIG. 2 is an illustration of a typical EPG in accordance with one embodiment;

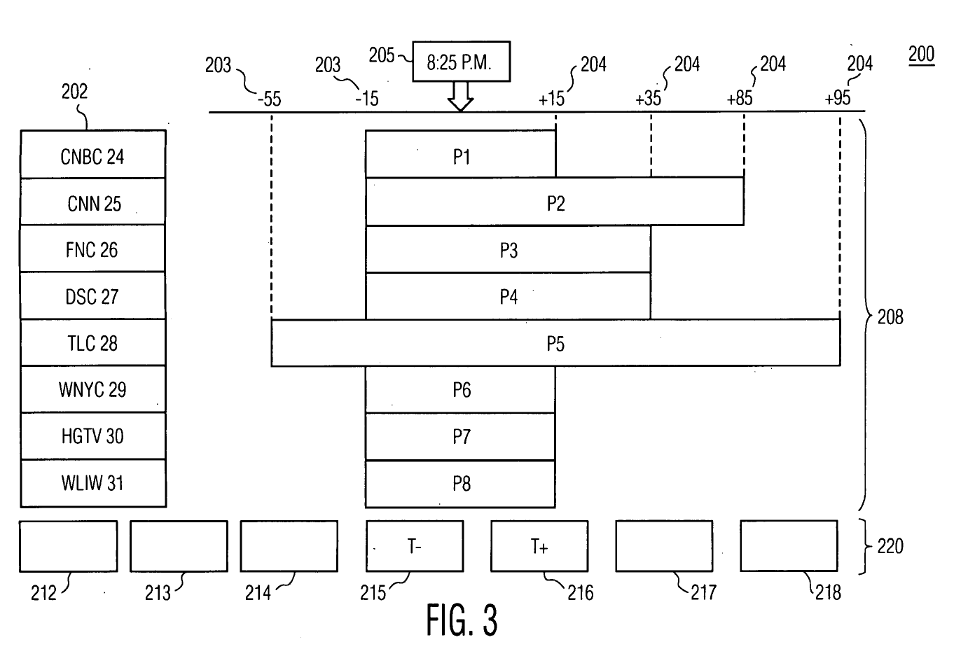

FIG. 3 is an illustration of the display of FIG. 2 for a different display time;

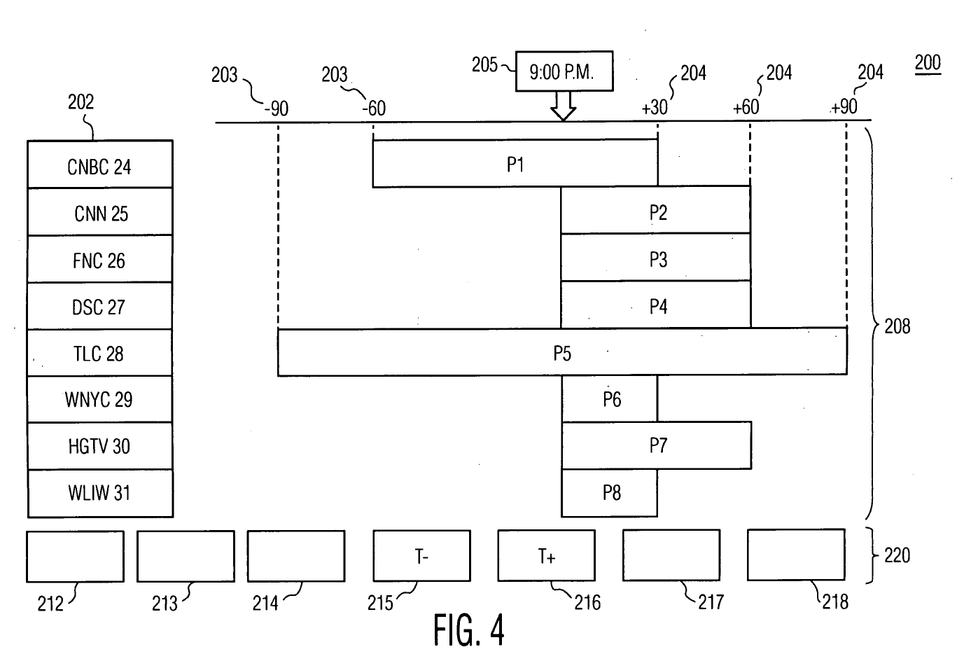

FIGS. 4-6 are illustrations of a typical EPG for describing the construction of a real-time favorites list;

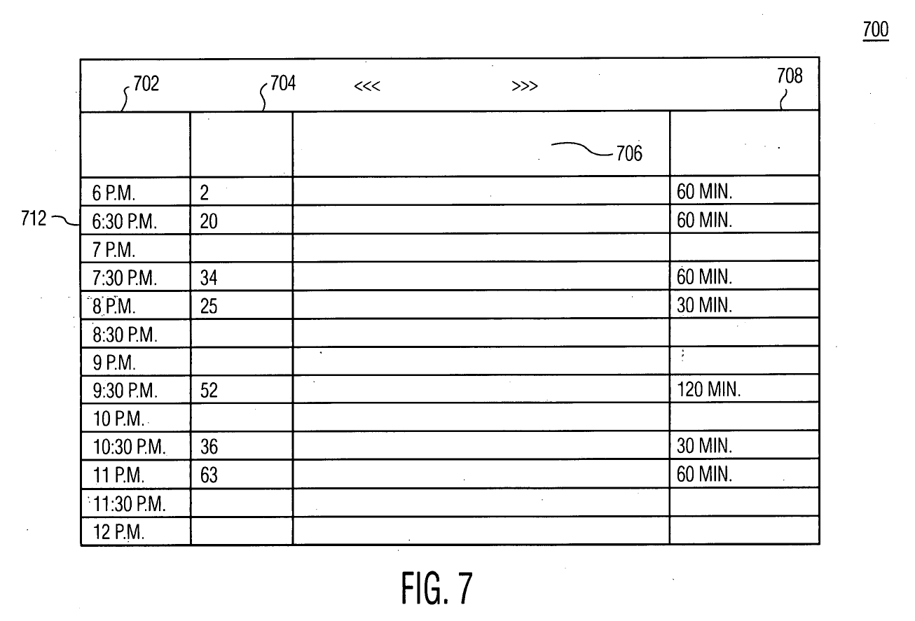

FIG. 7 is an exemplary display of a so-called “favorites list” that is shown to a viewer upon depressing the “Favorites List” button on the menu bar; and

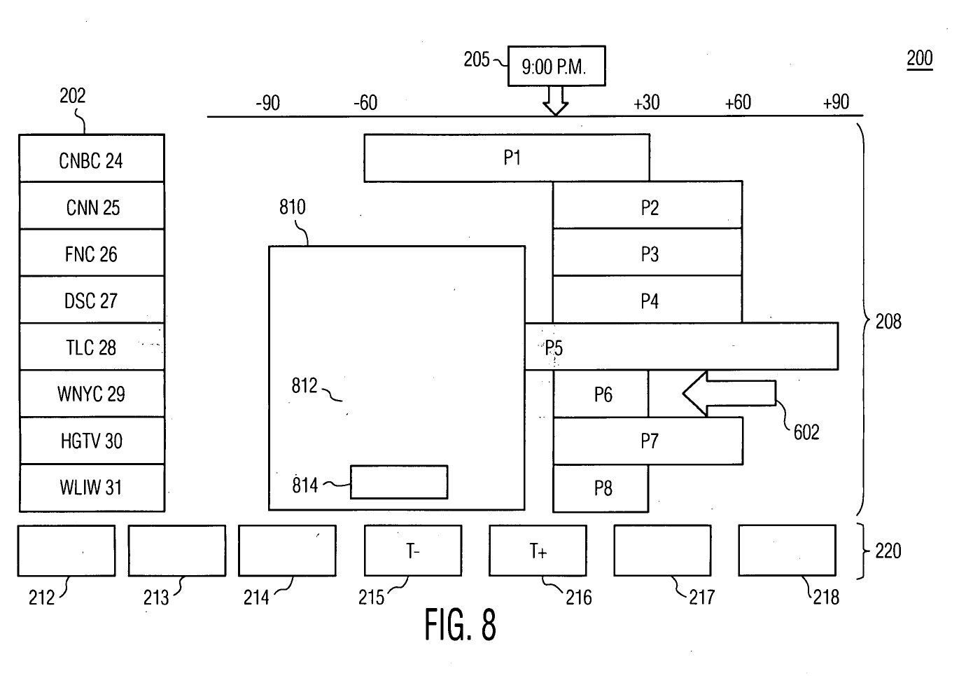

FIG. 8 is an exemplary display of a pop-up window that could be displayed to a viewer in response to the viewer depressing the “Favorites List” button on the menu bar.

The following description is presented to enable any person of ordinary skill in the art to make and use the present invention. Various modifications to the preferred embodiment will be readily apparent to those of ordinary skill in the art, and the disclosure set forth herein may be applicable to other embodiments and applications without departing from the spirit and scope of the present invention and the claims hereto appended. Thus, the present invention is not intended to be limited to the embodiments described, but is to be accorded the broadest scope consistent with the disclosure set forth herein.

The present invention provides a number of advantages over current EPG displays including allowing a viewer to quickly and easily find scheduling information of interest by displaying limited schedule information. Another advantage of the novel EPG display is the ability to display precise start and stop times for all of the displayed scheduling information. A further advantage is the ability to allow a viewer to highlight programs of special interest and construct a favorites list in real time.

It should be appreciated that preferred embodiments of the EPG display of the invention may be implemented either on a personal computer, a PCTV or a television connected to a set-top box. However, the invention is not limited to any particular hardware configuration and will have increased utility as new combinations of computers and television systems are developed.

Referring now to FIG. 2, an exemplary EPG grid 200 is illustrated according to one embodiment. The exemplary EPG grid 200 includes a column 202 to the left listing, for a particular cable system, the available channel number and an identifier for the network or channel associated with the various rows, as is conventional. At the top of the EPG grid 200, there is shown a user selectable time indication header 205 and a series of time tab increments 203, 204 demarcating the start and stop times in minutes for the displayed scheduling information relative to the time shown in the time indication header 205. The time tab increments 203, 204 demarcate the elapsed time 203 of each program relative to the time shown in the time indication header 205 and the time to completion 204 relative to the time shown in the time indication header 205. For example, for the cell labeled “P2”, broadcast on channel CNN 25, the program has already completed 15 minutes of broadcast air time and has +75 minutes of time to completion from the display time, 8:15 p.m., in the time indication header 205. As a further example, for the program “P5” broadcast on station TLC 28, the program has already completed 45 minutes of broadcast air time and has +105 minutes of time to completion from the display time of “8:15 p.m.”, in the time indication header 205.

A notable feature of the invention is the schedule information display portion of the EPG grid 200, generally shown as label 208. The schedule information display portion 208 displays a single column of scheduling information. In contrast with prior art EPG displays (as shown in FIG. 1), the schedule information display portion 208 only displays scheduling information for programs that are currently being aired for the current display time 205, e.g. “8:15 p.m.” selected by the viewer. In other words, the display portion 208 only shows those programs currently in progress as of the current display time of 8:15 p.m. Already completed programs and programs that have yet to start are excluded from the schedule information display portion 208 in contrast with conventional displays. The limited schedule information display portion 208 facilitates quick and easy identification of programs of interest to a viewer by reducing the complexity of the EPG display in the manner shown in FIG. 2.

Directly below the schedule information display portion 208 of the EPG grid 200 is a menu bar 220 which includes seven selection buttons or icons in accordance with one embodiment. Of course, other embodiments may choose to use a different configuration of selection buttons. Menu bar 220 includes help button 212, favorite button (RT-FAV) 213, add/delete button (ADD/DEL) 214, decrement time (T−) button 215, increment time (T+) button 216, favorites list button 217 and scroll button 218. Help button 212 is used to get viewer help information. Favorite button (“RT-FAV”) 213 is used to display a real-time favorites list on the screen, as will be described. The Add/Del button 214 is used to add or delete schedule information from the real-time favorites list. The T− 218 and T+ 219 buttons are used to respectively decrement and increment the display time 205. The favorites list 217 button is used to display one of a number of pre-stored favorite lists of programming channels. Each of the buttons of menu bar 220 will be discussed in more detail below.

It is noted that a viewer has the option at any point in time to enter a display time of the user's choosing. As one example, assume that the viewer enters a display time of “8:25 p.m.”, as shown in the time indication header 205 of FIG. 3. One way for the viewer to change the display time from “8:15 p.m.” as shown in FIG. 2 to “8:25 p.m.” as shown in FIG. 3 is by depressing the time increment (T+) 216 key. As the display time 205 is changed by the viewer, the schedule information display portion 208 will update accordingly to display only those programs that are scheduled to be broadcasting at the selected display time. The viewer selected display time could be any time, past, present, or future within some pre-determined time window for which scheduling information is made available from a broadcaster.

With continued reference to FIG. 3, for a viewer selected display time 205 of “8:25 p.m.”, it is noted that the same schedule information is displayed in the schedule information display portion 208 of the grid as was shown in FIG. 2 for the display time of “8:15 p.m.”. However, the schedule information display portions 208 of FIGS. 2 and 3 differ in one notable respect. That is, the series of time tab increments 203, 204 are changed in accordance with the changed display time. For example, for the program “P5” broadcast on TLC 28, the number of minutes completed relative to the newly selected display time is −55 minutes, for the display time of “8:25 p.m.”, (in FIG. 3) as compared with 45 minutes (in FIG. 2). Further, the number of minutes remaining until completion for program “P5” is +95 minutes, in FIG. 3, as compared with +105 minutes in FIG. 2. Similar time tab updates are shown for each of the other program listings. It is therefore shown that the time tabs are automatically updated in accordance with the changed display time 205.

The highlighting of favorite, i.e., viewer preferred programs from the EPG of the invention and the associated construction of a real-time favorites list is now described, by way of example, with reference to FIGS. 4-6.

Referring first to FIG. 4, it is assumed, for the sake of example, that the viewer has selected to view a display time of “9:00 p.m.” via the T+button 216 on the menu bar 220. It is further assumed that the viewer has a particular interest in program “P1”, broadcast on CNBC channel 24 as being a viewer favorite. To select program “P1” for inclusion in a real-time favorites list, the viewer would depress the “RT-FAV” button 213 on the menu bar 220.

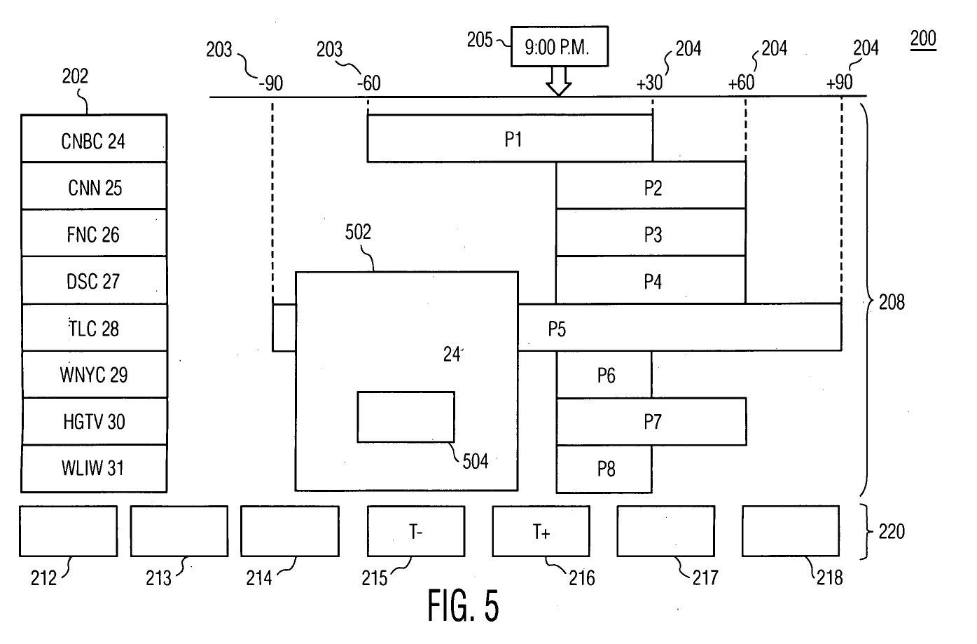

FIG. 5 illustrates exemplary EPG grid 200 shown to the viewer in response to the viewer depressing the “RT-FAV” button 213 at FIG. 4. Upon depressing the “RT-FAV” button 213 at FIG. 4, the viewer is shown pop-up window 502. Pop-up window 502 requests that the viewer enter a channel number to identify the program selection for inclusion in the real-time favorites list. Because only a single program is shown to be associated with each channel, identifying a channel number uniquely identifies program “P1”. The viewer may respond to the pop up window 502 by entering channel 24 and depressing the “Return” button 504. It is noted that the viewer has a change of mind and is not interested in the program choice, the viewer has the further option of not entering a channel number and depressing the “Return” button 504 which has the effect of negating the selection.

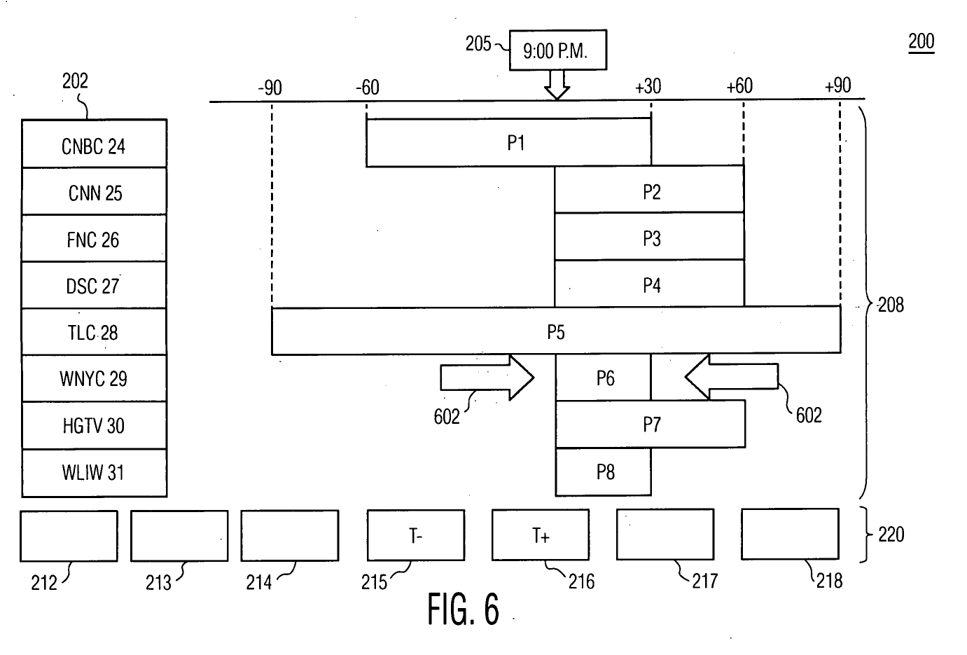

FIG. 6 illustrates exemplary EPG grid 200 shown to the viewer subsequent to making a “real-time favorite” program selection as described above. The exemplary schedule information display portions 208 of FIG. 6 includes highlight characters 602, highlighting the “real-time favorite” program selection made by the viewer as illustrated in FIG. 5. The highlight characters 602 will be displayed in association with program “P6” to provide visual notice to the viewer that the program was selected by the viewer as a “favorite” program. Thereafter, whenever the program “P6” is displayed to the viewer, the highlight characters 602 will be displayed alongside. Of course, highlighting could take any number of forms other than the one shown including, for example, blinking characters, a reverse lit programming schedule box, a program schedule box that extends from the screen in three dimension, and so on.

It is also to be appreciated that the viewer has the further option of choosing more than one program for the time period selected. That is, the viewer has the option of continuing to select programs of interest without limitation. When two or more scheduled programs are selected for the same time period, highlight characters would appear beside each of the selected programs. The viewer has the further option of deleting any highlighted program selections. This can be performed in one way by simply depressing the “RT-FAV” icon 213 and re-entering the program channel number corresponding to the highlighted program which would remove the highlighting characters and delete the program from the favorites list to be described.

In one embodiment, the highlighting feature may serve a dual function by serving as both a visual reminder of programs of interest to the viewer, and automatically tuning the television tuner to the highlighted program selection at the highlighted program's scheduled air time.

In another embodiment, the viewer could also be audibly advised of a selected highlighted preference at the time of airing by receiving an audible tone from the television's audio output.

In yet another embodiment, the viewer could also be visually advised of a selected highlighted preference at the time of airing by inserting an icon in the lower portion of the screen indicating that a highlighted programming selection is currently being broadcasted.

In addition to highlighting program choices, as described above, each selected program is further included in a so-called “favorites list” which may be retrieved by the viewer at any time by depressing the “favorites list” button 217 on the menu bar 220.

In operation, as the viewer makes highlight program selections based on preferred program choices, in the manner described above in connection with FIGS. 4-6, the preferred program selections are preferably stored in a database memory of the receiver or associated device (e.g., set top box).

FIG. 7 is an exemplary display of a so-called “favorites list” 700 that is shown to a viewer upon depressing the “Favorites List” button 217 on the menu bar 220. As shown, the first column of the favorites list is the start time 702 of each of the previously selected programming choices (i.e., highlighted programs), the second column lists the channel 704 of the program, the third column lists the title 706 of the program and the fourth column lists the running time 708 of the program. In the example of FIG. 7, it is shown that the viewer has previously selected, in real-time, 7 programs that the viewer considers to be favorite programs, and has appropriately highlighted those programs using the novel EPG of the invention. That is, each of the preferred programs shown in FIG. 7 were previously selected by the viewer as preferred programming choices in the manner described above with reference to FIGS. 4-6. The “favorites-list” provides the viewer with a quick and convenient way of viewing all of the selections made by the viewer in real-time which the viewer considers to be favorite programs. It is further noted that individual program entries in the “favorites-list” display of FIG. 7 can be deleted from the display by the viewer as an alternative to searching for and deleting individual program selections from the EPG display. In addition to the viewer deleting entries from the “favorites-list”, in one embodiment, the “favorites-list” could delete entries independently when the current time exceeds the run time of a particular program selection. For example, for the first entry 712 in the “favorites-list” display of FIG. 7 corresponding to the program title, “Dr. Phil”, the program start time is 6 p.m. and its run time is one hour. Accordingly, at 7:01 p.m., the “favorites-list” could purge the first entry 712 independently.

In one embodiment, multiple favorites lists could be constructed by the viewer. This could be accomplished, in one way, by providing a pop-up window in response to the viewer depressing the “Favorites List” button 217 which could provide options to create a new favorites list and store a currently highlighted program in a viewer selected “favorites-list”.

FIG. 8 is an exemplary display of a pop-up window 810 that could be displayed to a viewer in response to the viewer depressing the “Favorites List” button 217 on the menu bar. Pop-up window 810 includes four previously constructed “Favorite Lists”, i.e., a comedy favorites list, a sports favorites list, a news favorites list and a movies favorites list. The viewer has the option of adding a highlighted program to any of the four lists shown via the “Select ______” 812 entry means. The viewer has the further option of creating a new list via the “ENTER” button 814.

Although this invention has been described with reference to particular embodiments, it should be appreciated that many variations can be resorted to without departing from the spirit and scope of this invention as set forth in the appended claims. The specification and drawings are accordingly to be regarded in an illustrative manner and are not intended to limit the scope of the appended claims.

1. A method for displaying an electronic program guide (EPG) (200) to a Viewer to facilitate quick and easy identification of programs of interest to said viewer, said EPG (200) including a plurality of cells (208), wherein each of said cells (208) can contain program information, the method comprising the acts of:
displaying a viewer selected display time (205) disposed along one axis of said EPG (200) representing time;
displaying a first set of visual indicators (203) to the left of said viewer selected display time, each of said first set of visual indicators (203) indicating a respective time difference between said viewer selected display time (205) and a start time of the program information corresponding to each of said plurality of cells (208); and
displaying a second set of visual indicators (203) to the right of said viewer selected display time (205), each of said second set of visual indicators (203) indicating a respective time difference between said user selected display time (205) and an end time of the program information corresponding to each of said plurality of cells (208);
wherein said plurality of cells (208) include only program information that is scheduled to be aired by a broadcast system during said viewer selected display time (205).

2. The method of claim 1, wherein said first set of visual indicators (203) represents the number of minutes completed from the start of the program corresponding to each of said plurality of cells (208) to the currently selected viewer display time (205).

3. The method of claim 1, wherein said second set of visual indicators (203) represents the number of minutes to be completed from the currently selected viewer display time (205) to the end of the program corresponding to each of said plurality of cells (208).

4. The method of claim 1, wherein said first and second set of visual indicators (203) are relocated along said one axis in correspondence with a changed display time (205) and a changed cell position.

5. The method of claim 1, further comprising means for selecting certain cells (213) from said EPG (200) as viewer defined preferred program information (700).

6. The method of claim 4, further comprising highlighting means for highlighting said selected cells (602).

7. The method of claim 6, further comprising means for displaying a list (700) of said highlighted cells (217).

8. A system for displaying an electronic program guide (EPG) (200) to a viewer to facilitate quick and easy identification of programs of interest to said viewer, said EPG (200) including a plurality of cells (208), wherein each of said cells can contain program information, comprising:
means for displaying a viewer selected display time (205) centrally disposed along one axis of said EPG (200) representing time;
means for displaying a first set of visual indicators (203) to the left of said viewer selected display time (205), each of said first set of visual indicators (203) indicating a respective time difference between said viewer selected display time (205) and a start time of at least one of said plurality of cells (208); and
means for displaying a second set of visual indicators (203) to the right of said viewer selected display time (205), each of said second set of visual indicators (203) indicating a respective time difference between said viewer selected display time (205) and an end time of at least one of said plurality of cells (208);
wherein said plurality of cells (208) include only those programs that are scheduled to be aired by a broadcast system during said viewer selected display time (205).

9. The system of claim 8, wherein said first set of visual indicators (203) represent the number of minutes completed from the start of the program corresponding to each of said plurality of cells (208) to the currently selected viewer display time (205).

10. The system of claim 8, wherein said second set of visual indicators (203) represent the number of minutes to be completed from the currently selected viewer display time (205) to the end of a program.

11. The system of claim 8, wherein said first and second set of visual indicators (203) are relocated along said one axis with, a changed display time (205) and a changed cell position.

12. The system of claim 8, further comprising means for selecting certain cells from said EPG (200) as viewer defined preferred program information (213).

13. The system of claim 12, further comprising highlighting means (602) for highlighting said selected cells.

14. The system of claim 13, further comprising means for displaying a list of said highlighted cells (217).

15. An electronic program guide (EPG) (200) displayed on a display screen to facilitate quick and easy identification of programs of interest to a viewer, comprising:
a plurality of cells (208) containing program information and disposed in a single column, wherein each of said plurality of cells (208) include only those programs that are scheduled to be aired by a broadcast system during a viewer selected display time (205);
a display time (205) centrally disposed along one axis of said EPG (200) representing time;
a first set of visual indicators (203) disposed to the left of said viewer selected display time (205), each of said first set of visual indicators (203) indicating a respective time difference between said viewer selected display time (205) and a start time of at least one of said plurality of cells (208); and
a second set of visual indicators (203) disposed to the right of said viewer selected display time (205), each of said second set of visual indicators (203) indicating a respective time difference between said viewer selected display time (205) and an end time of at least one of said plurality of cells (208).

16. A computer-readable medium having stored thereon sequences of instructions which, when executed by a processor, cause the processor to perform the steps comprising:
displaying a viewer selected display time (205) centrally disposed along one axis of said EPG (200) representing time;
displaying a first set of visual indicators (203) to the left of said viewer selected display time (205), each of said first set of visual indicators (205) indicating a respective time difference between said viewer selected display time (205) and a start time of at least one of said plurality of cells (208); and
displaying a second set of visual indicators (203) to the right of said viewer selected display time (205), each of said second set of visual indicators (203) indicating a respective time difference between said viewer selected display time (205) and an end time of at least one of said plurality of cells (208);
wherein said plurality of cells include only those programs that are scheduled to be aired by a broadcast system during said viewer selected display time (205).

17. The computer-readable medium of claim 16, wherein said first set of visual indicators (203) represent the number of minutes completed from the start of the program corresponding to each of said plurality of cells (208) to the currently selected viewer display time (205).

18. The computer-readable medium of claim 16, wherein said second set of visual indicators (203) represent the number of minutes to be completed from the currently selected viewer display time (205) to the end of a program.

19. The computer-readable medium of claim 16, wherein said first and second set of visual indicators (203) are relocated along said one axis in correspondence with a changed display time (205) and a changed cell position.

20. The computer-readable medium of claim 16, further comprising a code segment configured to select certain cells from said EPG (200) as viewer defined preferred program information.

21. The computer-readable medium of claim 20, further comprising a code segment configured to highlight (602) said selected cells.
